(19) United States
(12) Patent Application Publication
(10) Pub. No.: US 2013/0090964 A1
(43) Pub. Date: Apr. 11, 2013

(54) Time on Site and Point of Interest Tracker with Privacy Block

(71) Applicant: MobiWork, LLC, Delray Beach, FL (US)

(72) Inventor: Herve Rivere, Delray Beach, FL (US)

(73) Assignee: MOBIWORK, LLC, Delray Beach, FL (US)

(21) Appl. No.: 13/649,773

(22) Filed: Oct. 11, 2012

Related U.S. Application Data
(60) Provisional application No. 61/545,963, filed on Oct. 11, 2011.
(60) Provisional application No. 61/545,957, filed on Oct. 11, 2011.

(51) Int. Cl. G06Q 10/06

(52) U.S. Cl. 705/7.13

(57) ABSTRACT

System converts GPS signals from worker's GPS-enabled device into task related time-location data by excluding private geo-data. Database holds task data, worker-device data. A web-based server captures and stores GPS data as task-related data when (a) contemporaneous GPS data is within predetermined distance of assigned task locations, (b) GPS data is in a task drive corridor (pre-approved geo), and (c) GPS data is vendor location (pre-approved). Enterprise templates are used to map trackable territories. GPS data not captured or stored is discarded or immutably filter-blocked. In a distributed system with the server and a supplemental computer, an im-filter at the supple-computer is controlled by the server. If not filtered, the server effects the storage of cleared GPS data into supple-computer storage by transfer of cleared GPS data to the supplement. The worker can turn OFF the GPS capture with temporary temporal controls. Enterprise templates are used to map trackable territories.

This is a regular patent application based upon and claiming the benefit ofprovisional patent application Ser. No. 61/545,963, filed Oct. 11, 2011, and provisional patent application Ser. No. 61/545,957, filed Oct. 11, 2011, the content of which is incorporated herein by reference thereto. This patent application also incorporates by reference the contents of U.S. patent application Ser/ No. ______, entitled “A Method and System to Analyze Time Stamp Location Data to Produce Movement and Idle Segments” filed Oct. 11, 2012.

The present invention relates to a computer-based method, system and computer program which converts GPS signals from a GPS-enabled device, carried by a mobile force team member, into task-related time and location data, and particularly, time on site data, while blocking private time, location and transit data obtainable from the GPS-enabled device carried by the team member.

The present invention generally relates to systems that automatically track the location of users. More specifically, the present invention relates to means for enabling users to control the manner in which such system obtain, disseminate and/or report user location information.

### BACKGROUND OF THE INVENTION

Numerous systems and methods exist for automatically tracking the location of users. Such tracking may be performed to support context-aware applications, to provide location-based services, or for a variety of other reasons. Tracking of users is often performed by tracking the location of a device or object uniquely associated with the user. For example, numerous mobile devices carried by users today include technology that enables the location of such devices to be determined with varying degrees of accuracy. Such technology may include but is not limited to Global Positioning System (GPS) technology, Wi-Fi technology, cellular telephony technology and Bluetooth™ technology.

Given that many methods exist for tracking the location of a user, a user may be rightfully concerned about how information about his/her location is being tracked, the nature of such information, and to whom such information is being reported. Unanticipated or unauthorized location tracking and reporting may justifiably give rise to fundamental concerns about user privacy and security. Users may not want certain entities or persons to know where they currently are, where they have been in the past, or where they are likely to be in the future for any number of reasons. Users who are concerned about location tracking may choose to divest themselves of technology that is capable of being used to track their location. However, by so doing, such users will then lose the benefits of that technology, despite all the advantages it brings typically in the context of a business with a mobile workforce.

There is a need for a system, method and a service to perform location tracking strictly limited to the context of the business (e.g. location of a customer, of a partner, or a task team member) non intrusively enabling a user to control the manner in which location information associated with the user is obtained, disseminated and/or reported by a location tracking system.

It is well known that service men and women and sales persons who visit customer locations throughout a wide geographic territory are oftentimes delayed in meeting appointment times. These appointment times are set, in advance to provide service, repair and goods to the customer at the customer location or site or to engage the customer in conversations and demonstrations in an effort to sell goods or services to the customer. With the advent of GPS-enabled electronic devices (cellular telephones, smart phones, tablet computers and other devices having GPS-enabled circuitry), it is easier for the person assigned to the task (the service man or salesman) to locate the customer. However, a problem still exists if a number of customers are scheduled for a single day or if the task person must visit other stores or locations to collect additional service personnel or equipment or supplies (vendor locations) in order to complete the task at the customer's location.

Databases and spreadsheets (a spreadsheet being a two dimensional database) have been developed to provide customer service and improve customer relations through the use of computer programs and computer systems. Notwithstanding these tools, business have experienced difficulty in monitoring mobile work forces and sales forces which need to visit the customer site to close a sale or repair equipment or provide other services at the customer's location. The present system and method seeks to solve problems associated with a mobile workforce.

### OBJECT OF THE INVENTION

It is an object of the present invention to provide a comprehensive mobile work force solution that improves work force capability, productivity and visibility as well as improve the quality of the customer experience.

The present system exploits the GPS features of a smart cellular telephone or a tablet computer with a web based platform which enables management and assigned task personnel to track, locate, capture data, and record events both automatically and manually to provide service to the business' customer.

It is another object of the present invention to provide an integrated platform for customers, work orders, tasks activities and parts and products inventory management and integrate smart phone features such as real time communication, location, navigation, audio information, image data, signature data and payment processing directly to the user's and customer's location.

Other objectives and advantages of the present invention are discussed later herein.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates a system diagram of the invention and various configurations of the method over a distributed computer system.

FIGS. 2A-2K diagrammatically illustrate tables with database fields or spreadsheet fields for one embodiment of the invention.

FIGS. 3A-3R diagrammatically illustrate configured tables for another implementation of the present invention.

FIG. 3Ea is a configured table for the assigned work orders and the notes sub-table with a privacy indicator. The privacy indicator shows when the privacy block (pr-XX) is ON, OFF, is temporarily active (temp) or if the GPS signal processor has been suspended for a short time.

FIG. 3Ha is a configured table for the assigned work orders—activity table, also showing the privacy block ON, OFF, temporary or suspended.

FIG. 4 diagrammatically illustrates an expanded “devices” table which is based, in part on FIG. 2J, and which shows privacy block and status conditions.

FIG. 5 diagrammatically illustrates a configured device ID table with a privacy block time sheet and calendar. The privacy block PR-XX is shown in certain time frames both for the task person, the task person smartphone and the task person computer tablet.

FIG. 6 diagrammatically illustrates multi-modal geo tracking with privacy guards both in a general flowchart (left column, a temporal flowchart, a spatial “everything but” flowchart and a spatial “only this” flowchart).

FIG. 7 diagrammatically illustrates an adaptive spatial tracking with privacy control routine and software module.

FIG. 8 diagrammatically illustrates the use of an immutable filter 39 in a simplified system diagram, indicating only certain components from FIG. 1 discussed earlier.

### SUMMARY OF THE INVENTION

The computer based method and system converts a substantially continuous GPS signal from a GPS-enabled cellular telephone, tablet computer or electronic device into task related time and location data by excluding private geo location data from the user's GPS-enabled device. Sometimes, this task related time and location data is referred to as “time on site” or “point of interest” data. The system utilizes a database populated by a plurality of tasks represented by unique task data collections and task person data. Each record in the unique task data collection includes task situs location, time on site data, task identifier data, task description, task assignment data, and task situs location data associated with the unique task. The task person data represents at least contact data for that task person assigned to the task. The database is coupled to a web-based processor which in turn is coupled to a telecommunications network. The GPS-enabled device, adapted to be carried by the task person, is coupled to the telecommunications network.

The method captures and stores GPS time stamp location data as task related data from the GPS enable device when (a) contemporaneous GPS data is within a predetermined distance of any one of the plurality of task situs locations assigned to the task person, (b) subject to pre approval prior to gathering the GPS signal data, contemporaneous GPS data within a drive corridor to any of the task situs locations, and (c) also subject to pre approval, contemporaneous GPS data within a vendor situs location for the unique task. The method discards GPS data which is not captured or stored or immutably blocks the same GPS data wherein the immutable filter is controlled by a trusted third party. The computer system employs a web-based interface which periodically gathers the GPS data from the GPS-enabled device. The web-based server includes a processor which captures and effects the storage of the contemporaneous GPS data as related above and the contemporaneous acceptance of GPS data in steps A, B and C. The computer system further includes a filter to block or discard GPS data which is not captured or stored. The distributed computer system includes a server which further includes means for determining the capture and storage of the contemporaneous GPS data as per steps A, B and C above. Additionally, the distributed computer system includes a supplemental computer having a supplemental database listing the tasks and task person data. The web-based server has a communications module to control the filter which blocks or discards GPS data. The controlled, immutable filter is operative on the supplemental computer. Alternatively, the computer system includes the blocking or discarding filter which is operative on the web-based server to block or discard GPS data which is not captured or stored in accordance with steps A, B or C above. In this embodiment, the web-based server includes a communications module to transfer contemporaneous GPS data which is not blocked or discarded to the supplemental database and the supplemental computer. The customer (as well as the task person or other registered user) may access the system via an ap (an access point) from a smart phone or via a voice telecommunications channel wherein the system employs an interactive voice response (IVR) module for the communication.

### DETAILED DESCRIPTION OF THE PREFERRED EMBODIMENTS

The present invention relates to a computer-based method, system and computer program which converts GPS signals from a GPS-enabled device, carried by a mobile force team member, into task-related time and location data, and particularly, time on site data, while blocking private time, location and transit data obtainable from the GPS-enabled device carried by the team member. Similar numerals designate similar items throughout the patent specification. Some abbreviations in the drawings and the patent specification are identified in the Abbreviations Table at the end of the specification.

### Basic System Description and Advantages

The system provides a comprehensive mobile workforce solution that improves workforce capability, productivity and visibility as well as the quality of the customer experience.

The system employs advanced software components, modules and data acquisition and processing methods which exploit the unique smartphone and computer tablet capabilities and a web-based platform enabling management and assigned task personnel to track, locate, capture data and record events both automatically and manually, thereby providing better service to the system operator's customers.

Customers, work orders, tasks, activities, parts/products and inventory management, forms, workflow automation, messaging and all the capabilities the smartphone brings (real-time communication, location, navigation, audio, image, signature, and payments) are seamlessly integrated into a series of user-friendly interfaces to empower the mobile workforce and provide a superior customer experience.

The system operator employs a web browser which is enabled at different levels of control for the front office, the back office, the assigned task person, task team members, management, and, to a limited extent to customers. These customizable interfaces provide real time results and time-and-location based planning and task execution. From the customer's view, he or she can now see the time-to-arrival and any impediments blocking the access to service, repair or sales call by viewing the customer portal.

The system uses smartphone capabilities (real-time communication, location, navigation, audio, image, signature, and payments)(also available from GPS enabled computer tablets and other GPS and telecom enabled devices) and integrates data from those devices with data from the front office, the back office, the task person, team members and management, and presents the same in an orderly fashion to the authorized party.

The system is suited for field services as well as other businesses that employ a fleet of mobile workers who execute activities outside of the office, such as sales, business development and customer service.

Application functionality and corresponding benefits are designed for mobile workers, managers, office coordinators and customers.

The GPS enabled cellphone, computer tablet or other electronic device with a telecom link is loaded with native applications that securely communicate over the Internet with the system operator servers, delivering inbound and outbound messages to track, exchange information and manage activities

Office coordinators and management log in to web portals to create and update customer data, work orders, tasks, establish appointments, send notifications and access reports. The system is an extension of the system operator's customer relationship management (CRM) system and enterprise relationship program (ERP) enabling the system operator to extend its existing platform to the mobile world.

Customers are provided with access to a secure web portal to review appointments, create new orders and track workers on a time-based format and a geo location format. The system can be further integrated with interactive voice recognition (IVR) features to provide an audio phone based interface for customers.

The system improves workforce capability, productivity and visibility, which translates to cost and time savings, increased revenues and peace of mind. The system permits the system operator to configure a unique customer access portal to view a wide range of task person data (time to customer location, current location, estimated impediments, customer enabled input to add or alter customer contact data (home phoe to cell phone to business phone). Accordingly, the customer is provided with more transparency and visibility, which results in a far superior customer experience and a competitive advantage.

Data acquisition and data processing modules are integrated together to provide a seamless and intuitive user interface at various control levels.

Customer Management Module (system operator (“Sys Op”) controlled): Customers (including prospects), contacts, locations, custom forms, notes, history, appointments, customer relationship details such as previous work orders, documents, billing, invoices and payments, customizable processing rules, bulk provisioning, and reports.

Work Order Management Module: Drag and drop appointment scheduling, automated route planning (based on schedules, locations) and optimization, automated creation based on rules (service contracts), location based directions and navigation, notes, invoicing and payments, history, customer relationship details such as previous work orders, products/parts and inventory management, documents (audio, images), custom forms, signature capture, customizable processing rules, and reports.

Task Management Module: Drag and drop ordering, list management, expected completion dates and automated reminders, resource assignment, categories, access control, location based directions and navigation, documents (e.g. audio, images), customizable processing rules, and reports.

Activity Management Module: Drag and drop management of appointments, work orders and task scheduling, with real times updates to both office and mobile workers, automated time and travel tracking and billing with real location data (e.g. expense reports management), automated mobile worker location and movement tracking, time-on-site analysis, plan versus actual metrics for analysis and optimization.

Notifications (including emergencies and high risk situations) Module: Send/Receive alarms, messages, automated notifications reminders whenever attention is required. In case of an emergency, the task person—mobile worker can notify the Sys Op in two (2) clicks on the smart phone that the task person needs immediate and urgent help. In high risk working conditions, the automated watchdog mechanism immediately notifies the Sys Op if a mobile worker is not responding.

Account Management Module (web only designed for office): Extensive workflow automation framework (rules, filters, actions) to automatically exploit all the underlying information (e.g. automatically determining that a mobile worker is going to be late for an appointment), forms definition (including subforms and dynamic number of items), extensive set of customization parameters (including custom print views for forms, invoices and work orders), access control roles/permissions (template based as well as custom, individual and/or group of users), plus automated inventory.

The system and method is smartphone and GPS-enabled tablet based. There is no need for custom hardware to be installed on a vehicle, and no need for mobile workers to carry a costly, bulky and slow laptop.

The system is platform agnostic in that the system works on GPS-enables cell phone such as: BlackBerry™, Android™ (Apple, Microsoft on roadmap), and iPhone™ and iPad™.

The system is carrier agnostic and works on any telecom carrier (e.g. AT&T, Verizon, T-Mobile, Sprint, VodaFone).

The system is customizable by the Sys Op for any particular business or service. The system uses XML based APIs to interface with 3rd party software.

### Smart Device Integration Features

The system and method exploits the software and hardware capabilities provided by the GPS-enabled smart electronic devices linked into the telecom system. The integrated features include: Navigation system including audio driving directions; Signature capture; Image capture; Audio capture; Video capture; Location capture; 1D and 2D (QR codes) bar codes capture; and Payment capture (including NFC when available)(near field communication payment systems).

Examples of these uses of the system are: (A) Delivery Service: Worker uses the system to view his next appointment, clicks on navigation for directions, arrives at the delivery point (location is tracked), scans a 2D code, captures customer signature. (B) Sales: Worker views list of customers/prospects to visit, upon arrival receives custom action checklist, allow customer to use QR code coupon, captures payment and signature. (C) Account Manager: Worker arrives at customer site, updates system database with latest info, adds audio trip report and photo, records video of customer testimonial.

The system and method provides Location Tracking and Movement Analysis.

Component Features such as (i) Advanced location tracking and reporting with multiple operating modes (continuous, business hours, points of interests) for privacy control and/or battery optimization. (ii) Automated movement intelligence including time on site and location-to-point-of-interest matching for idle segments. (iii) Privacy and access control framework to respect and guarantee the privacy of your employees. Integration with System rules engine to enable location & movement triggered actions.

Examples of these uses of the system are: (A) Mobile worker enters or leaves an area which triggers a ‘geofencing’ activity such as a billing timestamp, or an email alert to a customer when within 5 miles. (B) Mobile worker is leaving appointment, the system triggers a custom “System form” for worker to complete (e.g. appointment report). (C) Automatically track the amount of time spent at each customer by workers and deliver a report to management analyzing face time. (D) Automatically generate an alarm if a device/vehicle is moving at night, if an advertising truck is idle or outside the area it is supposed to be in. (E) Help to retrieve a lost device based on current or last known location. The geo-location tracking and the correspondence with the task situs and the time-on-site factor can all be integrated into a accounting and billing system which is useful to the system operator, manager and customer. In this manner, the system can be configured to send a message at the completion of the task to the manager and the customer. This proof of service feature is beneficial.

The system and method provides Workflow Automation enabled to provide: (i) A rules based framework based on triggers, filters and actions to customize the Sys Op solution to its business needs. (ii) Wireless forms framework. (iii) Notifications and Reminders framework. (iv) Extensive customization support.

Workflow Automation functions include: (A) An “Office” alert and display configured to create a custom form to be displayed on the smart device every Friday at 2:00 PM (time and day trigger) to enable input of a weekly status report. (B) The system can display a form or checklist when a worker arrives at an appointment. (C) Set a rule for a coordinator/worker/manager to be notified by email or text whenever a mobile worker is going to be late for an appointment. (D) Create a set of rules to detect abnormal conditions such as a vehicle moving at night or outside of a given area, or if a user is idle more than a certain amount of time (e.g. advertising truck).

The system and method provides Activity Scheduling, Tracking and Reporting to provide: (A) Drag and drop scheduling of appointments, work orders & task lists, with real times updates to workers. (B) Planned versus actual visualization and metrics, with the actual automatically created by this system component.

The system and method provides Mobile Planning by creating optimized route to save on fuel costs and limiting delays by finding the most efficient path in terms of mileage and traffic conditions.

The system and method provides privacy and access control framework for the task person.

A mobile worker's (task person's) schedule is updated during the day with a new and an optimized plan of activities, thereby eliminating paper plans and permitting the Sys Op to reduce paper and ink usage and achieve environmental goals.

The system and method provides Activity and Expense reports which can be validated by system audit trails. For example, a manager can receive a report every morning with activity details for entire mobile team: % late, % on site, which customers had access to the task person, face time with customers, and number of customer visits. A consulting services company can automatically track distance and time allocations of all their mobile workers to customers for billing purposes.

The system and method provides a Customer Self Service Portal with the following features. (A) A configurable and customizable web based portal which can be branded as needed by system clients. (B) A 24/7 real time view of work orders, with the ability to update or create new ones. (C) Visibility by customer into worker movement and arrivals. (d) An IVR phone based voice presentation to the customer portal. (D) Notifications via SMS (short message service) or email based on workflow rules. (E) Customer satisfaction monitoring via automated surveys.

The Sys Op decides to enable their customers to view location and estimated arrival time of visiting service worker by logging in to a secure web page, or to request to be notified when the mobile worker is within X predetermined miles of their location. The Sys Op Customer can provide quality related feedback via an online survey in the portal or by email. The Customer is able to order additional services via access to live work orders. This “add services/goods” feature permits the Sys OP, upon the real time request of its customer, to provide additional goods or services to the customer or enable cross selling of goods and services to the customer without requiring live human resource.

The system and method provides a Real Time and Secure Information Exchange with the following features: (A) Optimized for smartphone and limited bandwidth environments. (B) Caching mechanism to enable access to critical data even when the device is out of range. (C) Open set of APIs to enable extension of 3rd party applications such as ERP/CRM to the mobile world. (D) Mobile workers have immediate and real time access to the latest customer information, products, and inventory. (D) Customer profiles can be automatically relayed to the worker's handheld prior to arrival, resulting in a prepared worker and a superior service engagement (or first call resolution rate, or sales close). (E) Mobile workers can remotely update the customer profile, capture critical data from the field, perform form based reporting, execute payment/billing transactions, and any other high-value activity that system has enabled for a smart device.

The system and method provides a wide range of settings for the Sys Op as follows: (A) Global Settings—define the settings that apply to all the users of the company (SMS, customer portal). (B) Payment Options—configure the payment options for work orders (Retainer, Credit Card, PayPal). (C) Rule-based operations—configure system operation. (D) Work Orders (“WOs”)—configure work orders (the forms that are attached to a work order, the custom print view). (E) Customers—configure customers (the forms that are attached to a customer, the custom print view). (F) Forms Presentation and Data Input—configure Sys Op forms as data input and output templates. (G) Tasks—configure tasks (categories). (H) Activity—configure the custom activity types. (I) Quick Launch Settings—configure links that appear in the “Quick Launch” panel. (J) User Permissions Templates—configure the user permissions templates that can be assigned to users.

### Time-On-Site

The System Time-On-Site module is an automated tracking & reporting solution for organizations that need to analyze the amount of time their workers spend on site, but without infringing on their personal privacy.

The System Time-On-Site tracks the amount of time each worker spends at predetermined locations such as customer or project sites without tracking their personal or professional whereabouts and activities in between. If the Sys Op is interested in tracking and visualizing all movements and locations, the general system operations described above enables that feature.

System Time-On-Site provides automated and concise reports that are sent by email daily and weekly (time, day of the week, date, date range, frequency, destination are all fully customizable). In addition, the reports can be generated for any given time frame or combination of users via the web interface.

System Time-On-Site is a solution that provides key visibility and insight (e.g. which customer was visited and for how long, how long ago was that specific customer location visited and by whom?) while simplifying the day-to-day tasks of the Sys Op mobile workforce (automated activity report, expense report documentation and validation) as well as giving the task person or mobile worker the peace of mind that their privacy rights are secure and respected.

A summary of the Time-On-Site module follows. The GPS enabled smart phone or computer tablet or GPS enabled electronic device, with a telecom link, is carried by the mobile worker. The GPS enabled smart device contains a System Time-On-Site native application that captures the locations of the user—task person and securely communicates that geo location, time and date data to the system's web based servers. On the server side, the Time-On-Site module analyses those locations and computes actual movement versus idle segments. For each idle segment, System Time-On-Site searches from the list of predefined points of interest (for example, customer or partners address or a geographic area defined by a center point and a radius or predefined spatial region about the center point to find a match. If there is a match, the corresponding idle segment is saved and it will be used as part of the reporting. Otherwise, it is discarded.

Office Coordinators and Management automatically receive a daily and weekly summary report by email. These authorized Sys Op persons can also log in to their web portal for real-time access to the geo tracking information or to generate the report for a given time frame and user(s) and Geo-enabled devices.

Additional features of the Time-on-site module include: (i) Associate actions (email, forms to be filled out) whenever the mobile worker enters or leaves a location. (ii) Capture and visualize the entire path of the mobile worker (e.g. to automate and securely generate expense reports). (iii) Capture critical information from the field (payment, signature, audio, images). (iv) Use the system APIs to automatically provision and maintain the Sys Op list of relevant addresses. (v) Add automated surveys to ensure quality of service and get customer feedback.

### Details of the General System

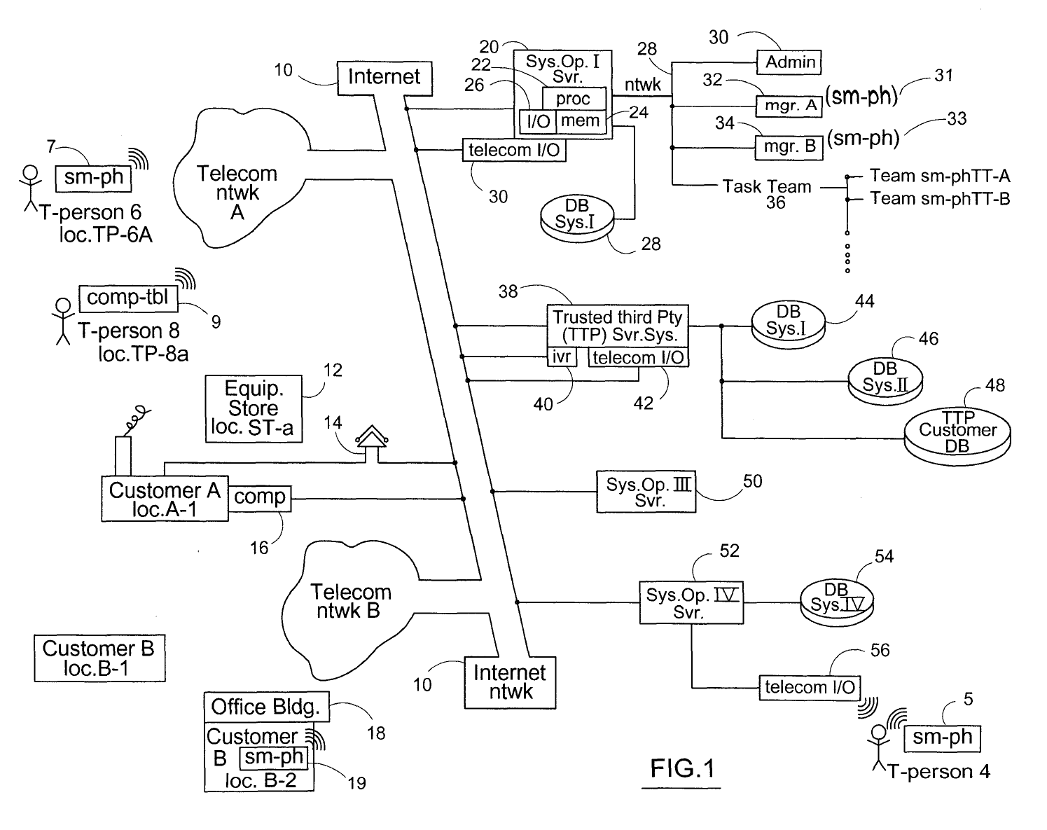

FIG. 1 diagrammatically illustrates a system diagram of the present invention. It should be noted that the method and computer system can be located on a singular server controlled and operated by single Sys Op, or, in the alternative, the method and system can be distributed over a plurality of computer systems and networks. FIG. 1 diagrammatically illustrates both a centralized operation of the method as well as a distributed operation of the method.

FIG. 1 shows a task person T-person 6 at location TP-6a. Task person 6 has a smartphone 7 which communicates via a cellular telecommunications network to telecom network A. Telecom network A is connected to internet 10 which in turn is coupled to a plurality of computer systems. Sometimes, the Internet is referred to as a telecom network. The general operations of these computer systems are known to persons of ordinary skills in the art. Only major system modules associated with the inventive system and method are discussed herein.

Task person T-person 8 is located at location TP-8a. Task person 8 carries with him or her a computer table 9 that has telecommunications link to Telecom Network A or Telecom Network B. Both smartphones 7 and computer table 9 and other GPS-enabled devices use a satellite supported global positioning signal (GPS) which is detected by devices 7, 9. The GPS signal is utilized by smartphone 7 and computer table 9 to mark its location and provide information to persons 6, 8.

These task persons may be required to visit equipment store 12 at location ST-a prior to visiting customer A at location A-1, customer B at location B-1 or any other customers. Customer A at location A-1 has a telephone 14 which is diagrammatically illustrated as being connected to the telecommunications network which includes Internet 10. Customer A also includes a computer 16 which is linked to a telecommunications network and ultimately to Internet 10. Telecom network A and telecom network B are either integral with Internet network 10 or can be effectively considered an extension of Internet 10 utilizing common telecommunications system such as land line, satellite and cellular telephone communications systems. Customer B has a service location at location B-1 but currently customer B is located in office building 18. Customer B carries with him smartphone 19. Office building 18 is at location B-2 which is distant from customer B location B-1. Therefore, when customer B who is carrying smartphone 19 needs to visit the service person or sales person at location B-1, the cell phone 19 of customer B should be utilized to arrange and coordinate the simultaneous visit of task person 6, 8 at location B-1 with customer B at location B-1. As discussed later, this coordination of both the service person or task person and customer B at distant location B-1 is accomplished.

Internet 10 or telecommunications network 10 is connected to System Operator I server 20. Server 20 includes a computer processor 22 and a memory system 24 and various input/output devices 26. These devices cooperate and permit Server I of System Operator I to communicate with database I 28. Additionally, System Operator I server 20 utilizes telecommunications input/output module 30 to communicate with smartphones 7, 19 and tablet computer 9 as well as customer A computer 16 via Internet 10, telecommunications networks A and B. System Operator server I is further connected to a network 28 linking the server I to an administrator computer 30, a manager A computer 32, a manager B computer 34 and various task team members 36. Task team members 36 have team member smartphone TT-A and smartphone TT-B. Manager A also has his or her cell phone 31 and manager B has her cell phone 33. As described later in conjunction with the Tables 2A to 2K and Tables 3A to 3R, System Operator I server 20 can fully engage all the features of the present invention.

However, there is a distinct benefit in utilizing the present method and the computer system in a distributed manner such as a software as a service (SAAS). In this distributed computer system and method, the present invention utilizes a trusted third party (TTP) server system 38. TTP server 38 includes all the elements customarily found in computer systems including interactive voice response (IVR) module 40 and telecommunications input and output module 42. TTP server 38 interacts with a plurality of databases effectively isolating sensitive data from System Operator I in database system I—44 from the data from System Operator II and database II—46. Customer data of the trusted third party System Operator 38 is stored in TTP customer database 48. Of course, a singular database may be utilized and different portions of that database would hold the secure or secret information for System Operator I as compared with System Operator II and as further compared with TTP customer database 48.

Internet and telecommunications network 10 is also connected to System Operator III server 50. System Operator IV server 52 is further connected to the telecommunications network 10. System Operator IV has access to database system IV—54. System Operator IV utilizes its own telecom input and output 56 which generates satellite communications links to task person 4 who retains smartphone 5.

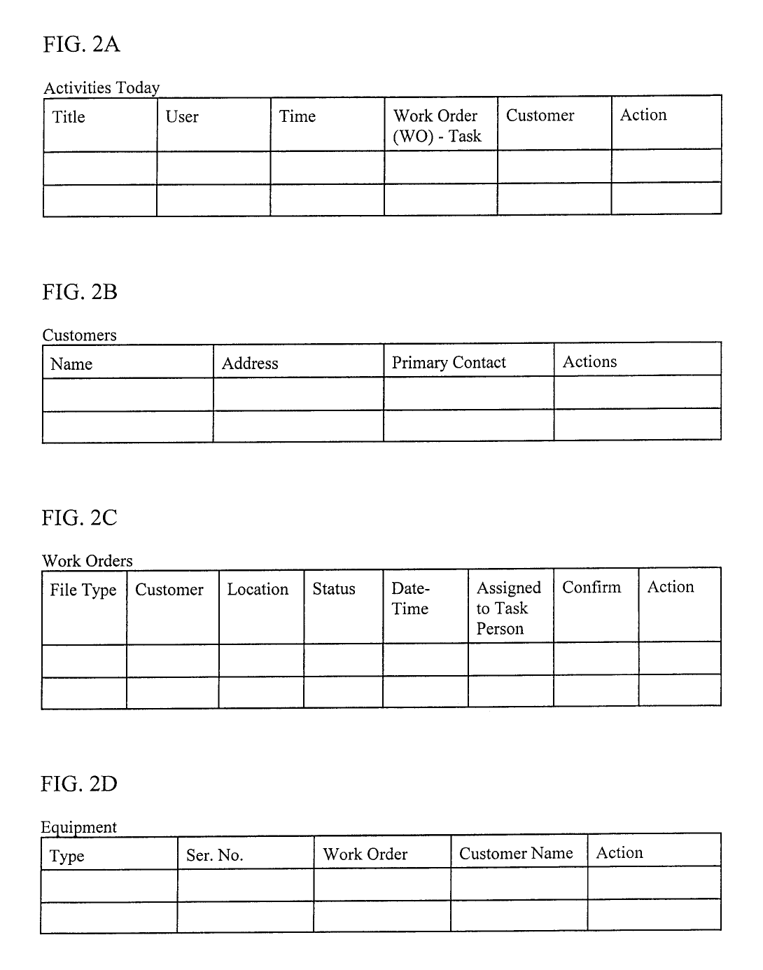

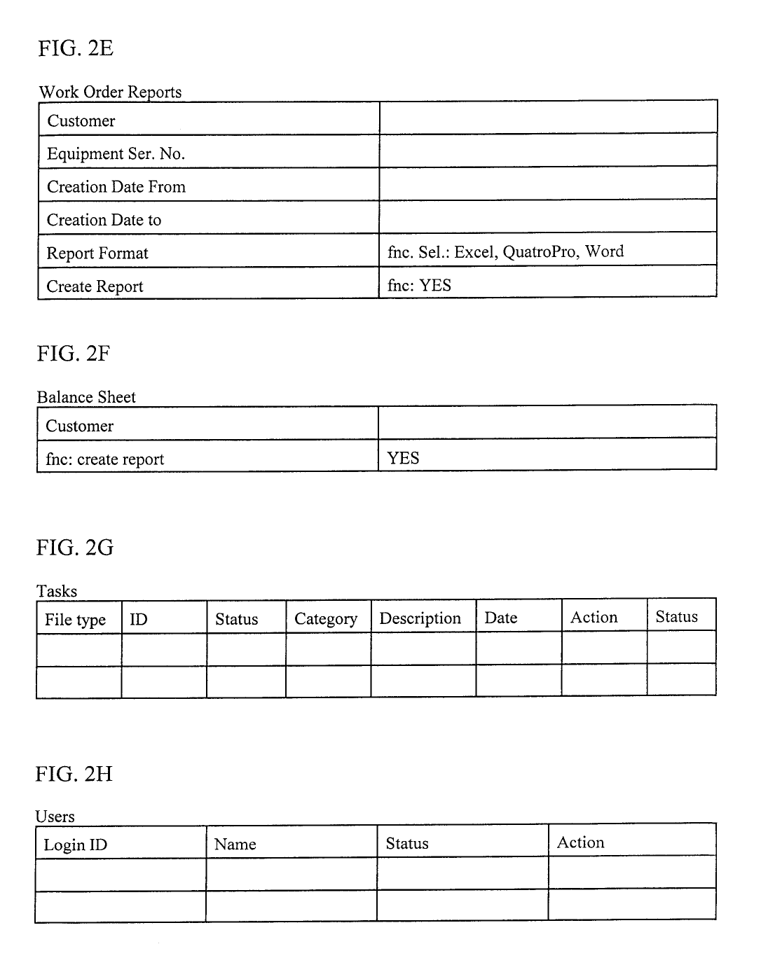

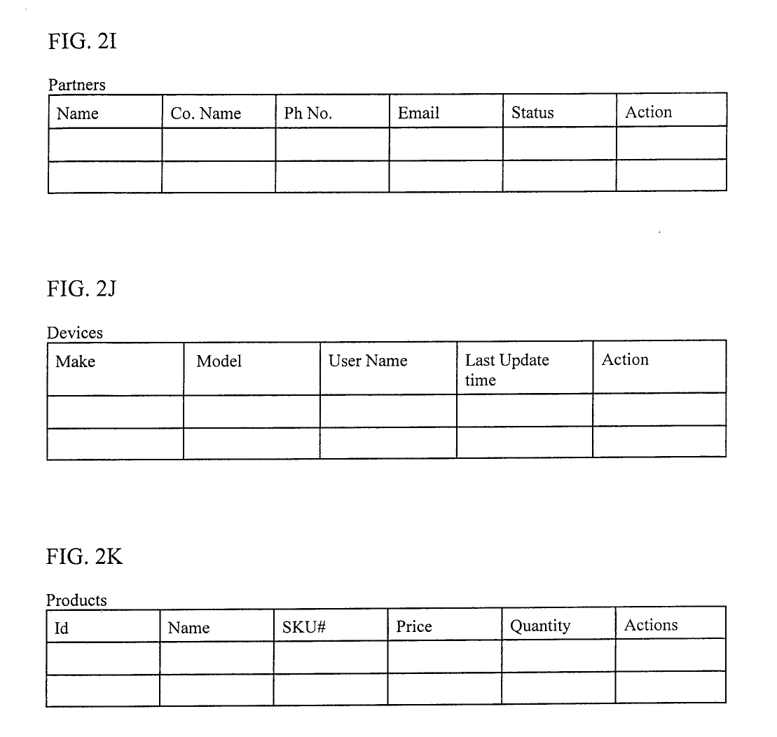

FIGS. 2A to 2K diagrammatically illustrate a number of tables having field identifiers which are useful for carrying out the basic elements of the present invention. In “activities today” table in FIG. 2A has data fields for the title of the activity, the user who is viewing the activity, the time of the activity as well as the work order (WO) task, customer in action. All these tables can be reconfigured to closely match the business of the System Operator.

The abbreviations used in the Tables and in FIG. 1 are sometimes identified in the Abbreviations Table at the end of this patent specification. Otherwise, abbreviations are identified in the description of the invention.

FIG. 2B shows a Customer's Table which includes name, address, primary contact at the customer location as well as action associated with the customer.

FIG. 2C is a work order WO Table which identifies: the type of file operative for the open work order, the customer, the customer location, the status of the work order, a date and time for the projected delivery of goods or services at the customer location, the task person, and a field for confirming whether the task person recognizes (ACK) the assignment or not and an action field.

FIG. 2D is a list of equipment necessary to provide the goods or services at the customer location.

FIG. 2E provides an outline for the work order reports. These reports are generated both prior to the work being delivered at the customer location and also while the task person is at the customer location. Identification of a function (“FNC”) is also shown in the Table. For example, under the “create report” header, the function (fnc) is YES which, when activated from the user on the smartphone or the web based interface portal provided by the system operator, the user (task person) can select YES generate the report and the system will generate an electronic fix copy of the report. In the absence of selecting YES, the system does not create the report. Hence, the create report has a function as identified in the table.

It should be noted that many, if not all, of these Tables are fully reproducible on smartphones carried by the user or task person.

FIG. 2F is a short form balance sheet for a particular customer. FIG. 2G is a “task table” that identifies: the file type, the identification number of the particular task, the status of the task (pending, closed, open), the category of the task, a task description, a “data action required” filed, and a “status” field.

FIG. 2H is a “user table” (a task person table) with a login identifier name, a status and an action required field.

FIG. 2I list a “partner” table. Partners are well established customers or suppliers. FIG. 2J is a table for “devices.” Typically, “devices” listed in the Tables are the GPS-enabled electronic devices, cellphones, smartphones, computer tablets and other GPS-enabled devices, all of which include a telecommunications link

FIG. 2K is a listing of the products.

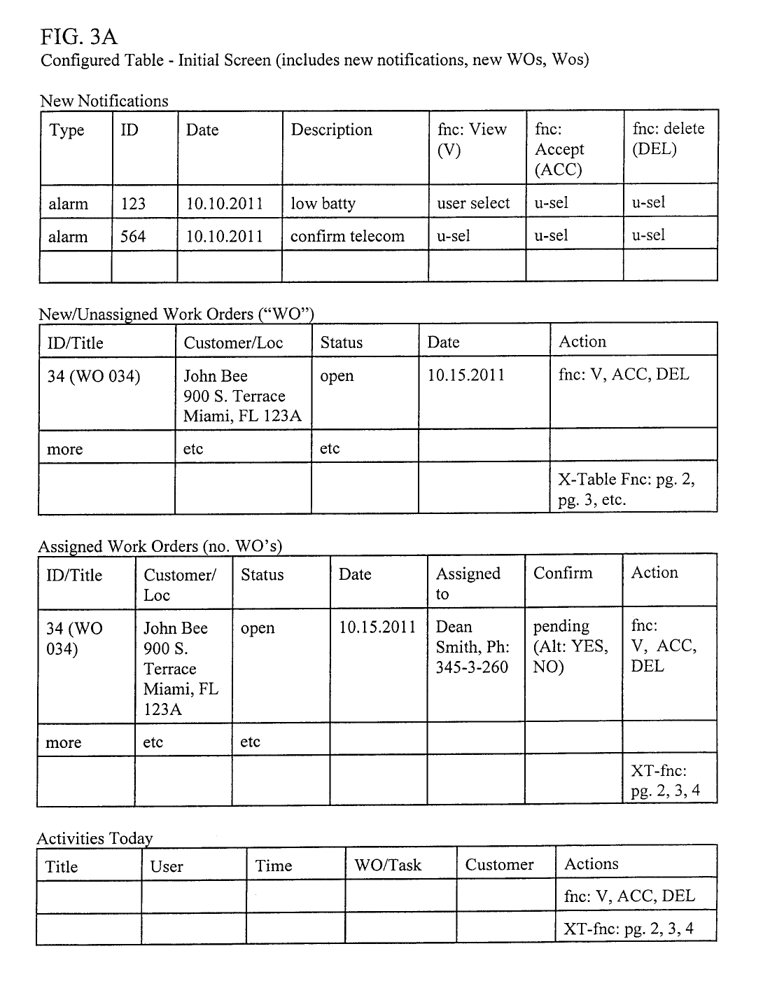

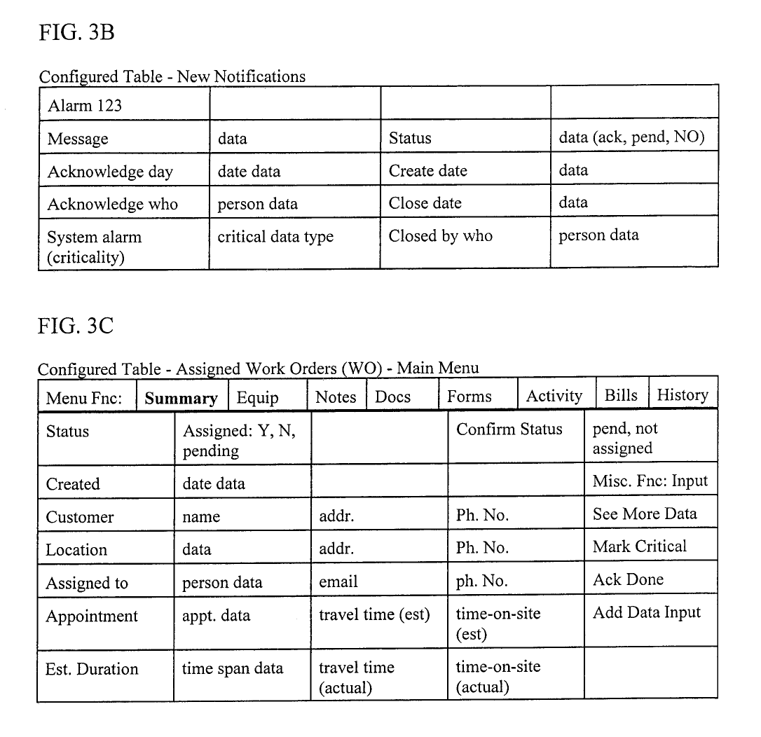

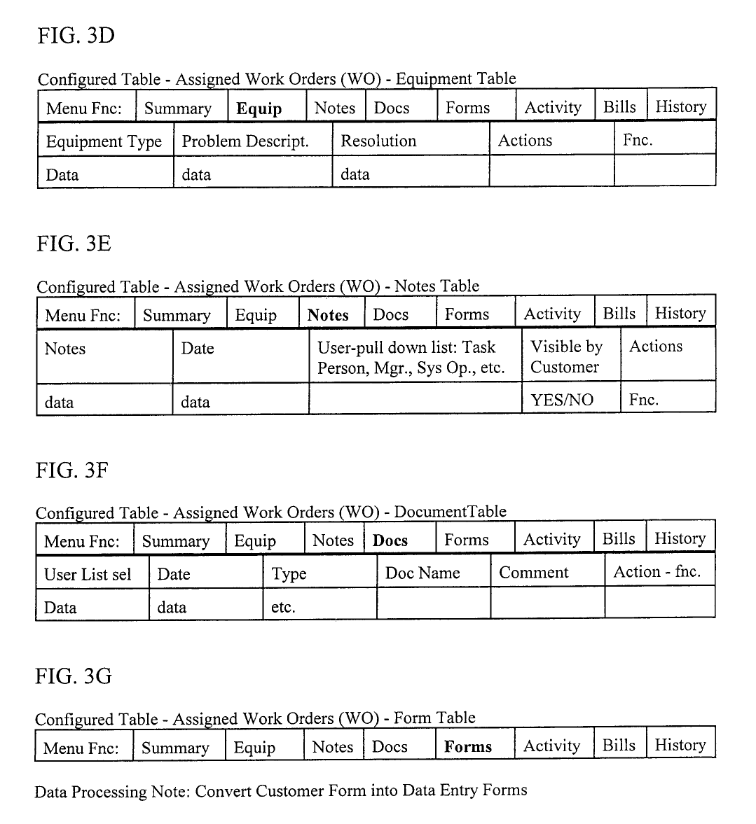

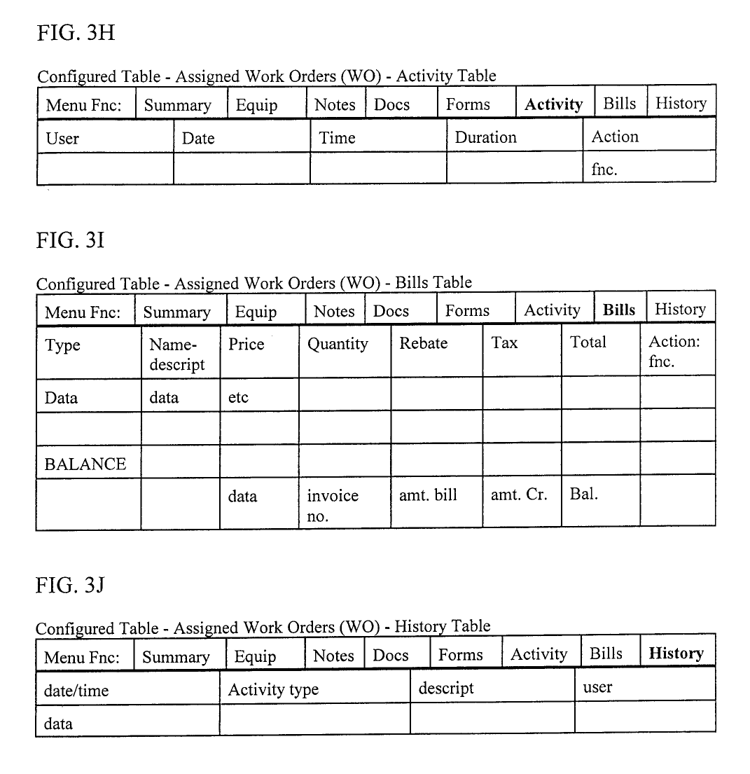

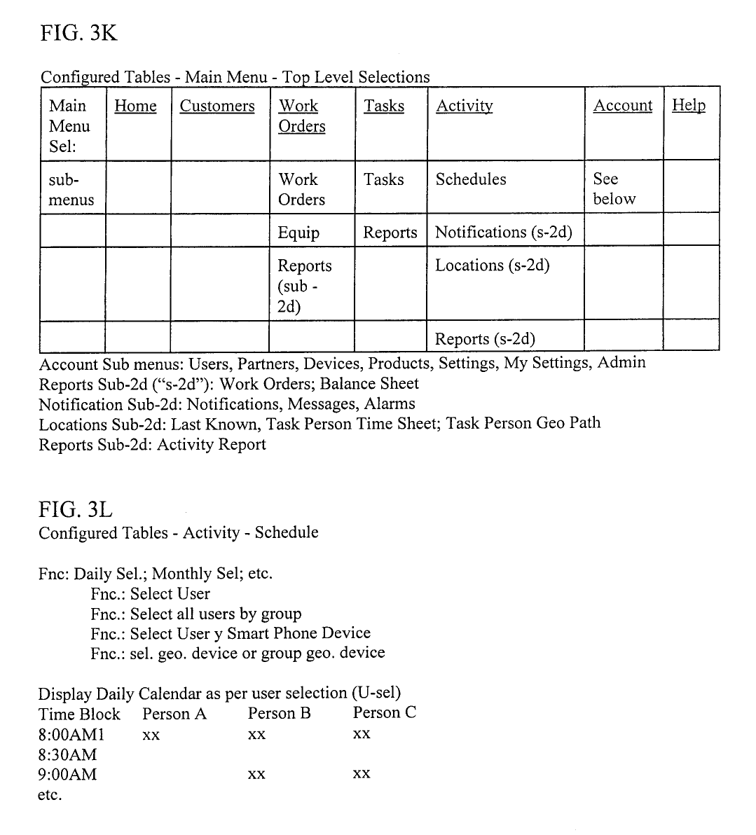

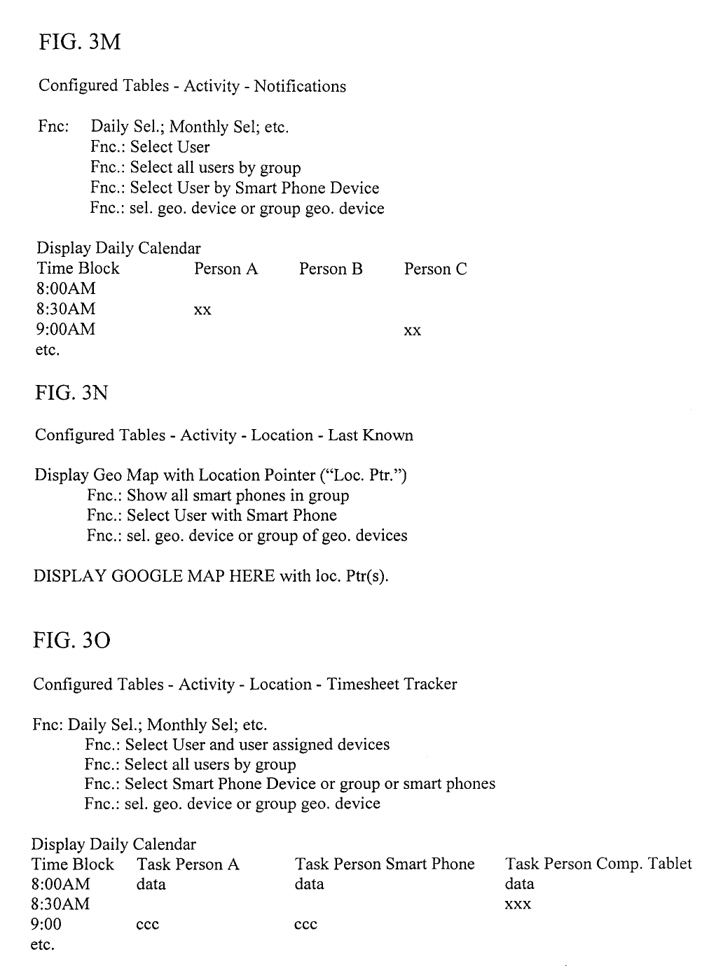

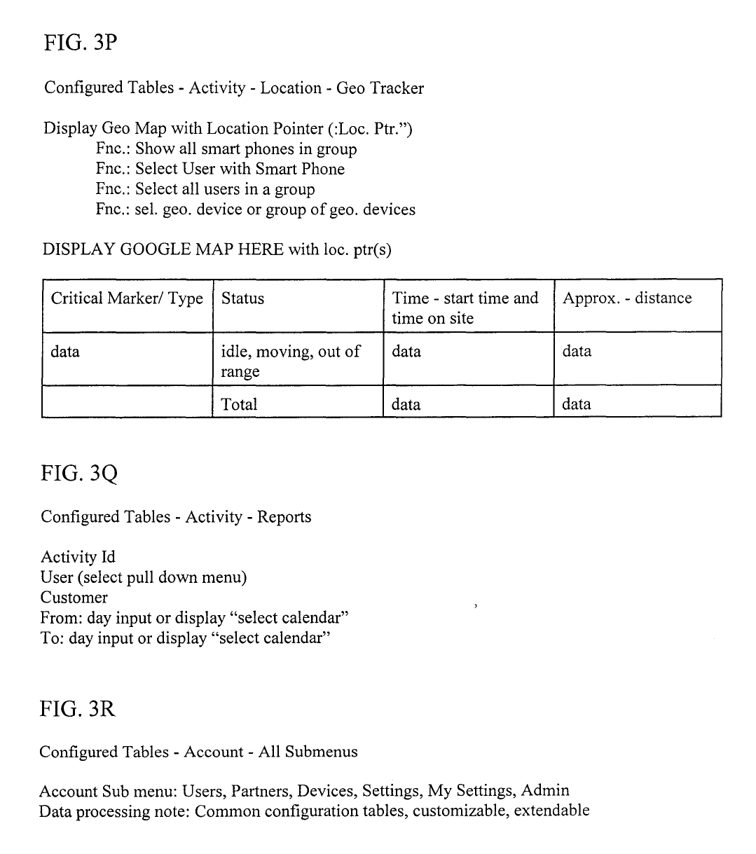

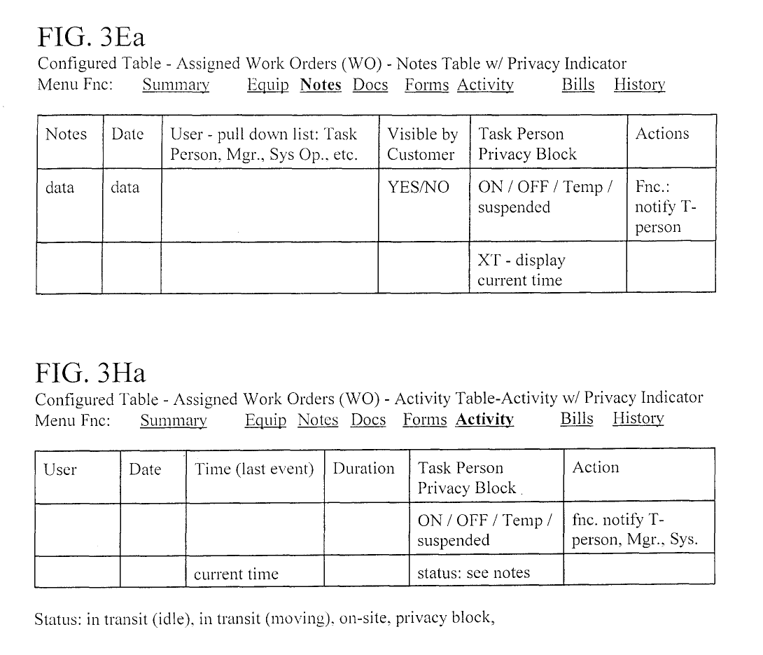

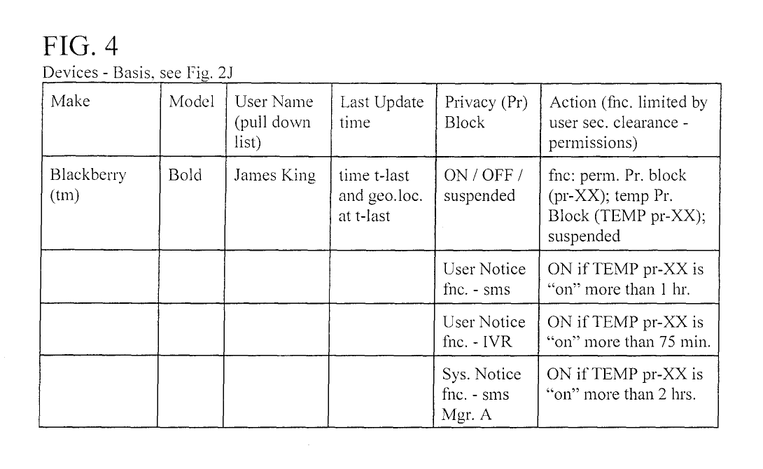

FIGS. 3A- 3R diagrammatically illustrate another group of tables which are partially complete and which represent a working embodiment of the present invention. FIGS. 3A-3R provide examples of the system. The system can be configured in various manners and the tables can be expanded or contracted to adapt to any particular business. However, FIGS. 3A to 3R represent at least one working embodiment.

FIG. 3A is a configured table showing the initial screen presented to the user who is logged in to the system. That screen includes four different sections a “new notifications” section, a “new-unassigned work order” section, an “assigned work order” section and an “activities today” section. This initial presentation can be altered by the user under his or her settings function. Under “new notifications,” the fields for the database or spreadsheet (a two dimensional database) include type, Id for the notification, date, description, a function enabling the user to view the entire alarm or notification record, a function to enable the user to accept the notification and another function to permit the operator to delete the notification record. The user may select to various functions and this is noted in these tables as “u-sel.” Therefore, a notification is set for an “alarm” with a notification id record “123” and is set for date “Oct. 10, 2011.” The event is a potential low battery on a particular GPS-enabled device. The user can view the entire record by selecting V (view), can accept the notification (ACC or ACK), or can delete the notification (del).

The “new-unassigned work orders” table is typically presented to managers of the System Operator. The identification and the title of the work order is provided in the far left column. The customer and a customer location listed in the next column. The status of the unassigned work order is open, pending or closed. Dates and actions are noted in the Table.

For “assigned work orders,” again, the title and id of the work force is provided, the customer, status, date and task person assigned to the WO is listed. Preferably, the phone number of the task person is also provided. This data is part of the task person data collection maintained in one or more of the databases 28, 44, 46, 54 in FIG. 1. As an example of a particular layout, the user is presented with certain functions external to the table identified as “X-Table fnc” or “XT-fnc”). Therefore, with respect to new and unassigned work orders, the user can select “go to page 2” of the unassigned work order, “go to page 3,” etc. With respect to assigned work orders, the external table function is abbreviated “XT-fnc.” The “Activities today” Table is self explanatory.

If the user or System Operator selects a particular notification from the initial screen, a table such as FIG. 3B is generated by the processor server 20 or 38. It is well known that computer systems and, in particular, web based computer systems utilize servers to provide a data display screen which enables the user at computer table 9, smartphone 7 and computer 16 to respond and input data and manipulate data presented by the server. FIG. 3B shows a configured table for new and old notification. The type of notification and id of the notification is indicated as “alarm 123.” This is the same “alarm 123” as identified in FIG. 3A. Therefore, FIG. 3B shows all the data collection or data record for that notification 123. The notification includes a message, the date the message was acknowledged (ACK), who acknowledged the message, a criticality indicator or alarm, a status of the notification, the creation date of the notification record, the date the notification was adequately responded to (closed date) and who closed the date. With respect to “status,” the data may reflect and acknowledgment ack, a pending indicator or a field to delete or indicate NO.

FIG. 3C is a configured table which the user sees once he or she selects the assigned work order WO from the main menu of FIG. 3A.

With respect to FIGS. 3C to 3J, the same menu functions are provided along the top row of the screen enabling the user to select a folder or directory under: summary, equipment records, note records, documents, forms, activities, bills and history. These directories or file selections are underlined in FIG. 3C-3J. The folder which is underlined and shown in bold has been activated in the particular figure. Therefore, FIG. 3C is a summary of the assigned work orders (“summary” shown in bold print), FIG. 3D is the “equipment associated” with a particular record, FIG. 3E are “notes” assigned to a work order, FIG. 3F are “documents” available for that particular work order. FIG. 3G is “forms” associated with either the equipment or the service to be provided to the customer for that work order. FIG. 3H is an “activity log” for the work order. FIG. 3I shows the bills or accounting for a particular work order and FIG. 3J shows the history of that work order.

Returning to FIG. 3C, the “summary” of the work order includes fields for status, date created, customer, location, the task assigned person, the projected appointment data, an estimate of the duration of the service (time on site) regarding how long the service person or sale person will be at the customer location. A confirmed status field as well as various functional inputs are provided. These functional inputs include the ability of the user who is viewing the FIG. 3C “work order summary” to “input” data, “see more data” on a particular field, “mark as critical” certain fields and aspects and data in that table, “acknowledge” that the work was done and “input more” data.

FIG. 3C also lists the travel time and the time-on-site which is calculated and stored as discussed later herein.

FIG. 3D is an equipment table associated with the work order. The equipment table can be changed to reflect any particular information necessary about the equipment.

FIG. 3E is a “note” associated with a particular work order. In FIG. 3E, the user can pull down a list of personnel such as the task person, the manager, the system operator, administrator. That selected person cna then annotate the Notes record for the work order WO. Therefore, the task person and anyone associated with that work order, such as task team 36 or manager A32 or manager B34 or administrator 30 can annotate the “note” record associated with a particular work order.

FIG. 3F are the “documents available” and FIG. 3G are “forms available” to the person. FIG. 3H shows an activity log for a particular work order.

FIG. 3I shows a billing table for a particular work order. FIG. 3J shows an accounting history for that customer.

It is important to realize that task person 6 carrying smartphone 7 or task person 8 carrying computer table 9 can access this information in Tables 3A-3R both prior to beginning the drive to equipment store 12, to customer location A-1 or to customer location B-1. In this manner, the information stored in all these tables is transparent to the entire management team.

FIG. 3K shows amain menu listing four top level selections. In other words, the user, when viewing the main menu, can select home, customer, work orders, task, activity, account or help. Sub-file or folders are available under the “work orders” folder which include work orders, equipments and reports. Under the “reports” sub-folders, is a series of secondary sub-folders or sub-subfolders which include work orders, and balance sheets. Under “task,” the sub-folders are task and reports. Under “activity,” the sub-folders are schedule, notification (with sub-folders notifications, messages and alarms), locations (with sub-subfolders last known, task person time sheet, task person geographic path) and reports (sub-subfolders activity report). The account main folder includes sub-folders for user, partners, devices, products, setting, my settings, and administration. Many of these tables and data input screen are discussed earlier in connection with FIG. 2A to 2K and 3A to 3R.

FIG. 3L shows a configured table for activity and schedule. The functions presented to the user include an option to select the daily time schedule for task person A, task B and task person C. Alternatively, the user can select a monthly calendar display. Additionally, the user may select all tasks assigned to a particular user or select “all users” by group name or select a user by smartphone or device. As stated earlier, the device is a listing of all the Internet and GPS-enabled devices carried by all task persons and managers administrators. Alternatively, the user can select the geographic device or group of geographic devices.

Under “display daily calendar” function, FIG. 3L has a vertical time blocks 8 AM, 8:30 AM and 9:00 AM extending down through the evening hours. The rows are identified by the Task Person A, B and C. If the user selects smartphone, the smartphone ids would be atop the column headers.

FIG. 3M is an “activity notification” Table which again shows a daily calendar identified by column headers for task person A, B and C. The user can select a single user in a monthly calendar display or all users in a daily calendar display as well as smartphone device or geographic or GPS-enabled device.

FIG. 3N is a last known location which displays a map with location points showing the last known location of a particular task person. The user can select smartphone in a group, or singular user with a smartphone as well as a GPS-enabled device or a group of GPS-enabled devices.

FIG. 3O is a location time sheet tracker. A display daily calendar shows task person A or task person smartphone or task person computer tablet with data filled in the row associated with a time block. Therefore, at 8:00 AM, task person A has data in their time block extending to 9:00 AM. Compared this data with the computer tablet listing only an 8:30 data entry. The user is permitted to select various users, groups or task persons or GPS-enabled devices.

FIG. 3P is a location and geographic tracker. This enables the user to select a task person, smartphone device, or various groups of devices. A map is displayed to the user and under the map is a critical marker Table identifying the critical nature of the task being reviewed. Maps from MapQuest™ or Google Maps may be used. Further, a status of the GPS-enabled device is shown. The status is idle, moving, or out of range. A total time of travel as well as a total of time on site is provided in this table.

The table beneath the geo tracking map also shows the start time as well as the time on site. An approximate distance to the customer location A-1 or B-1 is provided in this table.

FIG. 3Q discloses an activity Id, a user, customer and enables the user to input display or select calendar.

FIG. 3R discloses an “account” Table showing a sub-account for all users, partners, devices, products etc.

Details of the Time On Site and Point of Interest Tracker with a Privacy Block

The present invention relates to a computer-based method, system and computer program which converts GPS signals from a GPS-enabled device, carried by a mobile force team member, into task-related time and location data, and particularly, time on site data, while blocking private time, location and transit data obtainable from the GPS-enabled device carried by the team member.

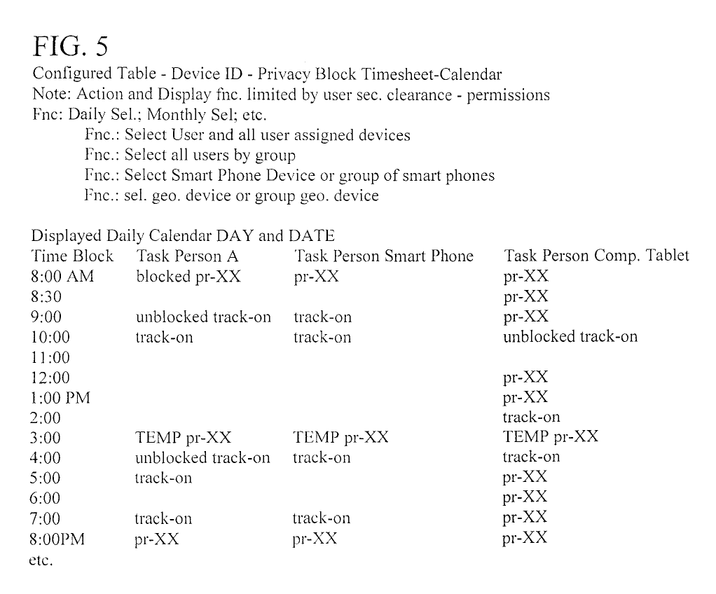

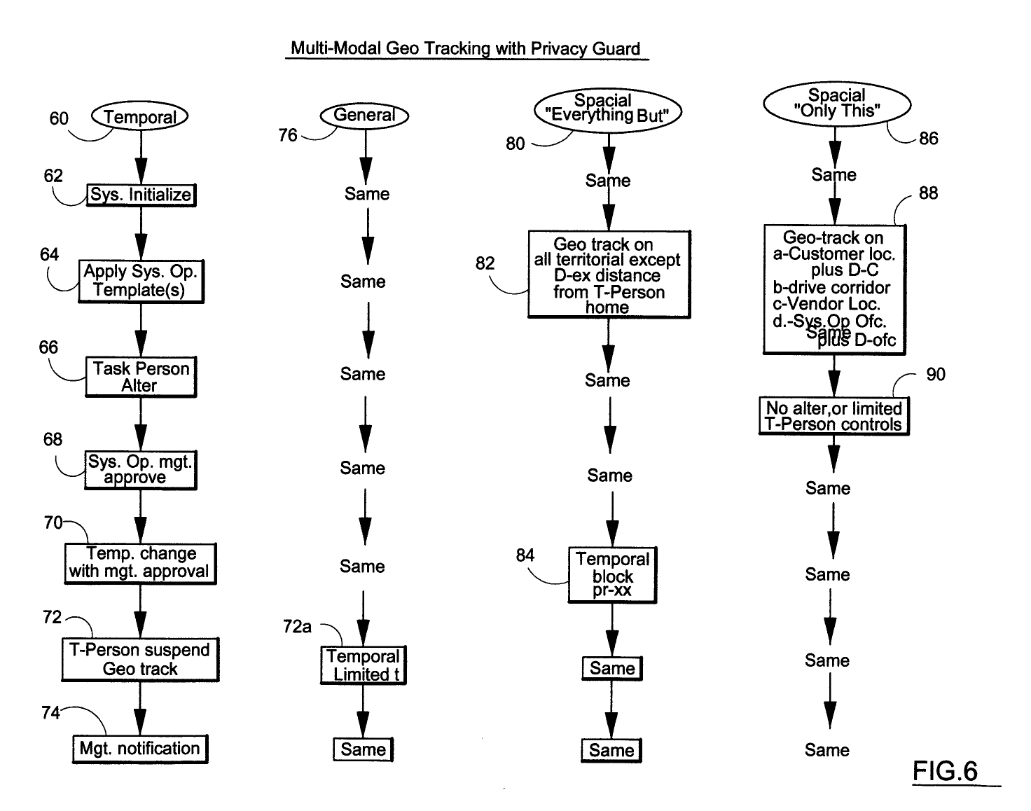

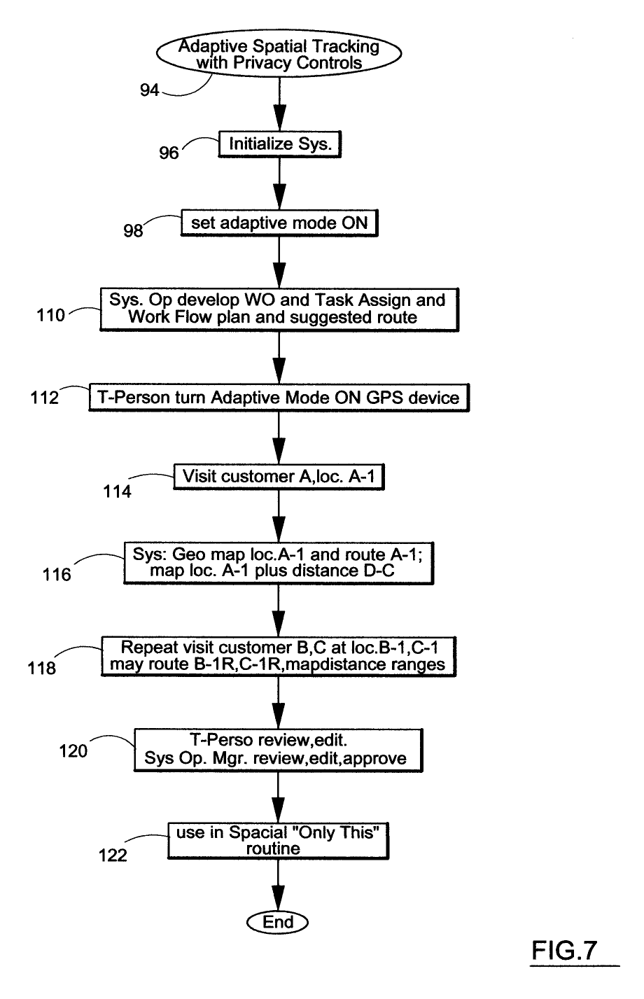

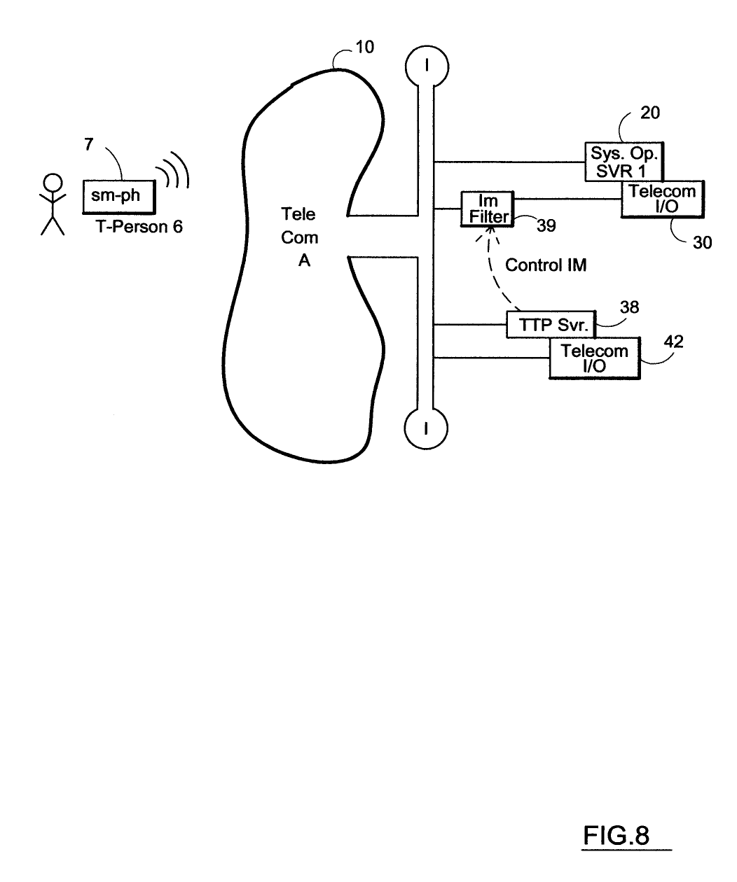

Details of the preferred embodiments of the invention are shown in FIG. 4 (an expansive “devices” table); FIG. 5 (a configured device ID table with a privacy block time sheet—calendar); FIG. 3Ea (a configured assigned work order—notes table with a privacy indicator); FIG. 3Ha (a configured assigned work orders—activity table); FIG. 6 (a multi-modal geo tracking program with privacy guards); FIG. 7 (an adaptive spatial tracking program); and FIG. 8 (which diagrammatically illustrates an immutable filter 39).

With respect to FIG. 4, the devices table (see earlier version in FIG. 2J) identifies the make, model and user or task person carrying that GPS-enabled device. The Table FIG. 4 includes the last time and GPS location from the GPS-enabled device and further includes a privacy block (“pr-XX”) ON-OFF-suspended indicator. The “action” column shows that the task person or user can change the privacy block configuration dependent upon the security clearance or authorization level of the user to change certain items. For example, the system operator should approve a permanent privacy block PR-XX, but a “temporary” privacy block may be set by the task person, employee, sales person, or service person. Further, a very short term privacy block can be implemented by the user (task person) under the “suspended” category.

FIG. 4 also shows various notice functions that can be triggered and set for the devices. For example, an SMS message may be sent to the task person if the temporary PR-XX block is ON for more than one hour. If the temporary PR-XX is ON for more than 75 minutes, a voice call by interactive voice response (IVR) is sent to the task person. On the other hand, if the temporary PR-XX is ON for more than 2 hours, the system may generate a notice via SMS or other notification (email) to manager A who is the supervisor of the task person.

FIG. 5 is a privacy block time sheet and calendar for the GPS device carried by the task person. Again, as explained earlier in conjunction with the other tables, these tables have controls by the user or task person, and managerial controls by group or GPS device. In the example of Table FIG. 5, task person A has smartphone as well as computer tablet. The table indicates that the task person has instituted a cell phone block PR-XX between Sam and 9 am. At that time, the task person unblocks the GPS cell phone unit. Therefore, by a control on the smartphone, the user can instruct the web-based server to turn ON and capture geo track data at 9 am. The task person also has instituted a “temporary” privacy block PR-XX between 3 pm and 4 pm. In contrast, the task person's computer tablet has been privacy blocked from Sam to 10 am and thereafter unblocked except for the lunch hour 12 noon to 1 pm. In this manner, the task person can control email and cell phone privacy.

FIG. 3Ea is the Notes Table for assigned work orders. The Notes Table has been modified to include a task person privacy block function.

FIG. 3Ha is the assigned work orders—activity Table which also has been modified to include a privacy block. It should be noted of that the privacy blocks can be further integrated into certain other tables such as the Table at FIG. 3C, the assigned work orders—main menu Table. The estimated travel time and estimated time of arrival should be altered to reflect privacy block either permanently installed by the task person (after approval by management) and, to some degree, temporary privacy block and the much shorter suspension privacy block under the control of the task person or user. A “suspension” privacy block function or operation, activated by the user on his or her cell phone or computer is operable for short periods of time such as 10 min. to 30 min. In one embodiment, supervisor approval is not necessary for this suspended privacy block.

The Table at FIG. 3L may be altered to list the privacy block. This activity-schedule daily calendar Table should indicate when the task person is not available for a task related activity.

With respect to Table FIG. 3N, the privacy block would override the location pointer mapping display on the displayed geo map. Enterprise templates may be used to map trackable territories. These enterprise templates turn ON the geo-tracking function in the system. When the T-P person is beyond the enterprise geo-territory, the system does not track the person, device or GPS-enabled unit.

With respect to Table FIG. 3O, the privacy block would also be used in the activity, location, time sheet tracker.

With respect to Table FIG. 3P, the tracking map would be blocked out to eliminate privacy blocked displays. Also, the table beneath the map or above the map should show privacy blocked out areas as blocked out time frames.

FIG. 6 shows four examples of flowcharts as multi-modal geo tracking with a privacy guard. The general flowchart 60 (left column) recognizes that the system must be initialized in step 62. In step 64, the system operator or manager applies the templates for the entire workforce or for the group workforce associated with the task person. In general, privacy policies are imposed both throughout the mobile work force and, more particularly, to group within the workforce. Therefore, the Sys. Op. should use a template establishing privacy policies for the entire workforce.

The template may exclude weekend and may exclude all times between 8 pm and 8 am as being privacy blocked. Therefore, although the GPS-enabled device carried by the user or task person is generating GPS signals and the servers 20, 38 are receiving those GPS signals, the contemporaneous GPS signals are blocked or filtered out if there is a privacy block PR-XX for that time frame or for the geographic location discussed later herein. The template at step 64 recognizes these privacy concerns. Step 66 permits the task person or user to alter the template initially provided by the system operator. Step 68 recognizes that the system operator or manager should approve any changes made by the task person. Step 70 notes that the user may request a temporary privacy block and that management should confirm any temporary change to pr-XX.

Temporary privacy blocks can be requested in accordance with the business policies of the system operator. For example, the system operator may have a business policy that any employee can request the time off to visit a doctor as long as 24 hour advanced notice is given. The temporary PR-XX is meant to cover the situation with pre-approval by the system operator or management. Step 72 recognizes that in certain situations, the user or task person may want to suspend the GPS tracker and impose a privacy block PR-XX for a short period of time. These suspensions are unexpected and considered to be shorter than the temporary block. In the case of a suspension longer than a predetermined period (for example, 15 min.) management is notified in step 74. Of course, all initiations of a suspension PR-XX many trigger a notification to the immediate manager.

In the next column, a temporal flowchart 76 is provided. Many of the steps in temporal flowchart which is exclusively time based are the same as the general flowchart 60. However, step 72a recognizes that the suspension PR-XX is for a limited or limited temporal condition t.

The next column 80 shows a spatial “everything but” routine. In this routine, the GPS-enabled device is tracked through an entire GPS covered region and only certain areas are excluded from the GPS gathering mechanism. In step 82, the system notes that the geo tracking or GPS data is captured or turned ON except for a distance D-EX around and about the task person's home. The task person may alter this excluded territory as noted in step 66 and in step 68 this alteration is subject to management approval. Step 84 recognizes that the user or task person may request a temporal or time based block for certain areas and times. The following step for the suspension PR-XX is the same as discussed in step 72, 74.

The far right column in FIG. 6 shows a flowchart 86 which is a spatial “only this” routine. This spatial “only this” routine uses data from the system operator to track mobile work force in customer designated areas. The task person and management must select which geographic areas are going to be active and subject to data accumulation by the system and the method herein. After system initialization (see step 62), the system activates step 88 which turns ON the geo tracking under conditions: (a) a customer location plus a predetermined distance D-c around and about a customer location; (b) a drive corridor to and from the customer location; (c) a vendor location (as well as drive corridors to and from the customer location); and (d) the business office or service office of the system operator plus a distance D-ofc around and about the business office or service office of the system operator.

As explained above in connection with tables 3A-3R, the location of the customer is already provided in the system database. Further, the location of vendors selling equipment and supplies is available. The system operator office and service areas should also be readily available. In step 90 the task person either has no ability to alter these active geo tracking areas or has very limited ability to control the “only this” geo tracking The other step of applying a temporary PR-XX or a suspension of the geo tracking is the same as discussed in steps 68 through 74.

FIG. 7 diagrammatically illustrates an adaptive spatial tracking with privacy control routine or module 94. The system is initialized in step 96. This initialization includes login in the GPS device, login in a task person information as well as customer data and system operator data. Step 98 sets the adaptive mode ON. Effectively, the adaptive mode is a “learning” mode wherein the system follows the task person and/or manager for the task person thereby establishing a drive corridor as well as the customer location. In step 110, the system operator develops a work order and assigns the task for the work order and a work flow plan, which customer should be seen in which order, and a suggested route. In step 112, the task person turns ON the adaptive on his or her GPS device. Step 114 involves a visit by the task person (and possibly the manager) to customer A at location A-1. The task person may activate a certain command or control on his or her GPS-enabled device to “mark” customer location A-1. In step 116, the system marks the geographic map location A-1 and the route A-1 and associates the route with a drive corridor. The drive corridor mapping can be expanded by corridor D-corr. Further, the system will expand a territory about and around location A-1 indicating a distance D-c for that customer A.

Step 118 involves a repeat of the system steps with respect to customers B and C at locations B-1 and C-1. The system operator and, more importantly, the system itself maps the routes B-1R, C-1R and maps the distance ranges about the drive corridors as well as customer locations B-1 and C-1. In step 120, the task person reviews the customer location, and turns ON geo tracking area about each customer and the drive routes. The task person may review and edit it the ONLY THIS track map in a very open work place. The system operator manager can also review, edit and approve the final geo tracking area and drive corridor. In step 122, this geo track ON area is applied in the spatial “only this” routine discussed earlier.

FIG. 8 diagrammatically shows a portion of FIG. 1. However in FIG. 8 a distributed computer system is employed wherein only certain information is supplied to System Operator Server I. An immutable filter (IM filter) 39 is either under the control of trusted third party TTP server 38 or, in a different embodiment, the TTP server 38 only sends non-private or cleared GPS located data to System Operator Server I. The System Operator Server I operates in conjunction with a supplemental database DB28. In one configuration, the TP server 38 employs a privacy filter which blocks GPS data that falls within a privacy block. The privacy block may either be a time or temporal based block or may be a geographic limited block. In such a situation, TTP server 38 includes a communications module such as telecom I-O 42 which transfers contemporaneous GPS data which is not blocked or discarded to the supplemental database 28 of supplemental computer 20.

In another embodiment, the IM filter 39 is under the control of TTP server 38. In this embodiment, once the IM filter 39 is set by TTP server 38, only cleared GPS data is fed to System Operator Server I.

Utilizing the tables and software routines and modules discussed above, contemporaneous GPS data is only stored in conjunction with the particular user or task person when that GPS is (a) within a predetermined distance of a customer location or task situs location, which customer location is assigned to a particular person; (b) the contemporaneous is within a drive corridor; (c) the contemporaneous data is within a vendor location and that vendor location is assigned to the task person; and (d) when the GPS data is within a predetermined distance of at least one predetermined point of interest assigned to the task person. Of course, a “point of interest location” could be a vendor location, could be a secondary or tertiary customer, or any other item of interest important to the system operator or reasonable to the task person. Typically, the task list assigned to a particular user is over a predetermined task related time period. The task related time in most mobile workforces is a singular work day. However, for independent sales people, the predetermined task related time may be an entire week. The manager or system operator may not be concerned as to which customer the independent salesperson visits in any particular week as long as all the customers in a predetermined geographic territory are visited within a one month time. The present system with both a temporal condition and a spatial condition can be configured for these different workforce conditions.

Pre-approval typically refers to a joint decision between the system operator and the user or task person. However, the system operator always has the ultimate control over the scope of the GPS data. Once a business protocol is established with privacy blocking, it is in the best interest of the system operator to honor that privacy protocol. Exceptional or extenuating circumstances may require a high level managerial override of any particular privacy block. Further, governmental regulations and subpoenas may adversely affect the privacy block for a user.

### Description of Typical System Features

The present invention relates to an enhanced mobile workforce planner and tracker deployed over GPS-enabled devices and enabling access to workforce data via computer systems, over the Internet and on a computer network (LAN or WAN), and computer programs, computer modules and information processing systems to accomplish these planning and tracking services.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but maybe practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

In the drawings, and sometimes in the specification, reference is made to certain abbreviations. The following Abbreviations Table provides a correspondence between the abbreviations and the item or feature.

Abbreviations Table

| | |
|---|---|
| Admin | Administrator |
| ap | an access point |
| API | application program interface |
| ASP | application service provider - server on a network |
| bd | board |
| comm. | communications, typically telecommunications |
| comp | computer with Internet access |
| comp-tbl | computer tablet with GPS and telecom link |
| CPU | central processing unit |
| db | data base, may also refer to a spreadsheet |
| | (a two-dimensional database) |
| Disp | display or code |
| doc | document |
| dr | drive, e.g., computer hard drive |
| Equip | equipment |
| fnc | function such as V = View, ACC = Accept task; DEl = delete |
| | entry; ACK = acknowledge receipt of comm. |
| Geo | geographic location or data (geo.loc. is GPS data) |
| GPS | geo positioning system and location (optionally time data) |
| HR | human resources or regional manager |
| I/O | input/output |
| Int | Internet network (part of the telecom network) |
| loc | location |
| loc. ptr. | displayed location on a displayed map |
| mem | memory |
| Mess | message as in SMS or text message |
| mgr. | manager in the Sys Op administration |
| ntwk | network |
| pend | pending, such as a posted task, not yet completed |
| pgm | program |
| proc | processor, as in computer processor |
| Pty | party, as in Trusted 3^{rd} Party (“TTP”) |
| P/W | password |
| Rcd | database record or record profile |
| re | regarding or relating to |
| Reg'd | registered as in Reg'd Pro, Registered Provider |
| rel | release |
| req | request |
| rev | review |
| Rpt | Report |
| rt | real time, may include day and time stamp data |
| sec | security |
| Sel | select |
| sm-ph | smart cellphone with GPS |
| SR | sales representative |
| sys | system |
| Sys Op | System Operator |
| t | time, sometimes refers to day and date and time of day |
| T-person | task person who is assigned a task |
| Tbl | table, may be configured as a database or spreadsheet |
| telecom | telecommunications system or network |
| URL | Uniform Resource Locator, or other network locator |
| u-sel | User selects function |
| WO | work order |
| X-tbl | a selectable user function displayed beyond the grid line |
| | of the data table |

What is claimed is:

1. A computer-based method to convert substantially continuous GPS signal data from a GPS-enabled cellular phone, tablet computer or electronic device into task-related time and location data by excluding private location data, the method operative with a database populated with a plurality of tasks represented by unique task data collections and task person data, each one of said unique task data collections having task situs location data, time-on-site data, task identifier data, task description, task assignment data, and vendor situs location data associated with said unique task, said task person data representing at least contact data for that task person, said database coupled to a web-based processor which in turn is coupled to a telecommunications network, said GPS-enabled device coupled to said telecommunications network, the method comprising:
capturing and storing GPS time stamped location data as task-related data from said GPS-enabled device when:
(a) contemporaneous GPS data is within a predetermined distance of any one of said plurality of task situs locations assigned to said task person,
(b) subject to pre-approval, contemporaneous GPS data is within a drive corridor to any one of said plurality of task situs locations assigned to said task person,
© subject to pre-approval, contemporaneous GPS data is within a vendor situs location for the unique task assigned to said task person, and;
either discarding GPS data which is not captured and stored or immutably blocking GPS data which is not captured and stored with an immutable filter controlled by a trusted third party.

2. A computer-based method as claimed in claim 1 wherein said GPS time stamped location data is obtained via a web-based communications channel between said web-based processor and said GPS-enabled device adapted to be used by said task person assigned to said unique task.

3. A computer-based method as claimed in claim 1 including:
discarding or blocking GPS data when contemporaneous GPS data is within a predetermined distance of at least one predetermined point of interest location assigned to said task person.

4. A computer-based method as claimed in claim 1 wherein said drive corridor to any one of said plurality of task situs locations assigned to said task person is established over a predetermined task-related time period.

5. A computer-based method as claimed in claim 4 wherein said predetermined task-related time period established for said drive corridor is a singular work day.

6. A computer-based method as claimed in claim 1 wherein pre-approval of said drive corridor is prior to said unique task data collection and task assignment data being associated with said task person.

7. A computer-based method as claimed in claim 1 wherein pre-approval of said drive corridor and pre-approval of said vendor situs location is prior to said unique task data collection and task assignment data being associated with said task person.

8. A computer-based method as claimed in claim 1 including discarding or blocking contemporaneous GPS data based upon a task person initiated temporal privacy request.

9. A computer-based method as claimed in claim 8 wherein said temporal privacy request is processed by said web-based processor more than a predetermined time period prior to the acquisition of said contemporaneous GPS data subject to said temporal privacy request.

10. A computer-based method as claimed in claim 1 wherein either said drive corridor or said vendor situs location is obtained in conjunction with a learning task configured as one of said plurality of unique task data collections.

11. A computer-based method as claimed in claim 1 wherein said conversion of said substantially continuous GPS signal data into task-related time data is deployed over said web-based server and a supplemental computer system having a supplemental database populated with said plurality of tasks and plurality of unique task data collections and said task person data, the method further including:
said web-based server either discarding GPS data which is not captured and stored or immutably blocking GPS data which is not captured and stored with said immutable filter on said supplemental computer system.

12. A computer-based method as claimed in claim 11 wherein said web-based server is associated with said trusted third party and which controls said immutable filter.

13. A computer program stored in non-transitory computer readable media for converting substantially continuous GPS signal data from a GPS-enabled cellular phone, tablet computer or electronic device into task-related time and location data by excluding private location data, the method operative with a database populated with a plurality of tasks represented by unique task data collections and task person data, each one of said unique task data collections having task situs location data, time-on-site data, task identifier data, task description, task assignment data, and vendor situs location data associated with said unique task, said task person data representing at least contact data for that task person, said database coupled to a web-based processor which in turn is coupled to a telecommunications network, said GPS-enabled device coupled to said telecommunications network, comprising:
capturing and storing GPS time stamped location data as task-related data from said GPS-enabled device when:
(a) contemporaneous GPS data is within a predetermined distance of any one of said plurality of task situs locations assigned to said task person,
(b) subject to pre-approval, contemporaneous GPS data is within a drive corridor to any one of said plurality of task situs locations assigned to said task person,
© subject to pre-approval, contemporaneous GPS data is within a vendor situs location for the unique task assigned to said task person, and;
either discarding GPS data which is not captured and stored or immutably blocking GPS data which is not captured and stored with an immutable filter controlled by a trusted third party.

14. A computer program stored in non-transitory computer readable media as claimed in claim 13 wherein said GPS time stamped location data is obtained via a web-based communications channel between said web-based processor and said GPS-enabled device adapted to be used by said task person assigned to said unique task.

15. A computer program stored in non-transitory computer readable media as claimed in claim 13 including:
discarding or blocking GPS data when contemporaneous GPS data is within a predetermined distance of at least one predetermined point of interest location assigned to said task person.

16. A computer-based method as claimed in claim 13 wherein said drive corridor to any one of said plurality of task situs locations assigned to said task person is established over a predetermined task-related time period.

17. A computer-based method as claimed in claim 16 wherein said predetermined task-related time period established for said drive corridor is a singular work day.

18. A computer-based method as claimed in claim 13 wherein pre-approval of said drive corridor is prior to said unique task data collection and task assignment data being associated with said task person.

19. A computer-based method as claimed in claim 13 wherein pre-approval of said drive corridor and pre-approval of said vendor situs location is prior to said unique task data collection and task assignment data being associated with said task person.

20. A computer-based method as claimed in claim 13 including discarding or blocking contemporaneous GPS data based upon a task person initiated temporal privacy request.

21. A computer-based method as claimed in claim 20 wherein said temporal privacy request is processed by said web-based processor more than a predetermined time period prior to the acquisition of said contemporaneous GPS data subject to said temporal privacy request.

22. A computer-based method as claimed in claim 13 wherein either said drive corridor or said vendor situs location is obtained in conjunction with a learning task configured as one of said plurality of unique task data collections.

23. A computer-based method as claimed in claim 13 wherein said conversion of said substantially continuous GPS signal data into task-related time data is deployed over said web-based server and a supplemental computer system having a supplemental database populated with said plurality of tasks and plurality of unique task data collections and said task person data, the method further including:
said web-based server either discarding GPS data which is not captured and stored or immutably blocking GPS data which is not captured and stored with said immutable filter on said supplemental computer system.

24. A computer-based method as claimed in claim 23 wherein said web-based server is associated with said trusted third party and which controls said immutable filter.

25. A computer system converting substantially continuous GPS signal data from a GPS-enabled cellular phone, tablet computer or electronic device into task-related time and location data by excluding private location data, a web-based server coupled to a telecommunications network and further coupled to said GPS-enabled device, said server maintaining a database populated with a plurality of tasks represented by unique task data collections and task person data, each one of said unique task data collections having task situs location data, time-on-site data, task identifier data, task description, task assignment data, and vendor situs location data associated with said unique task, said task person data representing at least contact data for that task person, comprising:
a web-based interface on said server and in communication with said GPS-enabled device, said interface periodically gathering GPS time stamped location data from said GPS-enabled device adapted to be used by said task person assigned to said unique task;
said web-based server having a processor means for capturing and effecting the storage of storing contemporaneous GPS data as task-related data from said GPS-enabled device when:
(a) said contemporaneous GPS data is within a predetermined distance of any one of said plurality of task situs locations assigned to said task person,
(b) said contemporaneous GPS data is within a drive corridor to any one of said plurality of task situs locations assigned to said task person,
© said contemporaneous GPS data is within a vendor situs location for the unique task assigned to said task person, and;
a filter to block or discard GPS data which is not captured and stored.

26. A computer system as claimed in claim 25 wherein said filter is an adaptive filter which changes said drive corridor to any one of said plurality of task situs locations assigned to said task person over a predetermined task-related time period.

27. A computer system as claimed in claim 26 wherein said predetermined task-related time period for said drive corridor is a singular work day.

28. A computer system as claimed in claim 25 including a task person initiated temporal filter to block or discard contemporaneous GPS data, said task person initiated temporal filter corresponding to a temporal privacy request obtained more than a predetermined time period prior to the acquisition of said contemporaneous GPS data.

29. A computer system as claimed in claim 25 wherein said computer system is a distributed computer system, wherein:
said server includes means for determining when said contemporaneous GPS data is within a predetermined distance of said any one of said plurality of task situs locations assigned to said task person, means for determining when said contemporaneous GPS data is within said drive corridor to any one of said plurality of task situs locations assigned to said task person, and means for determining when said contemporaneous GPS data is within a vendor situs location for the unique task assigned to said task person, and,
the distributed computer system includes a supplemental computer having a supplemental database populated with said plurality of tasks and plurality of unique task data collections and said task person data;
said server having a communications module to control said filter which blocks or discards GPS data which is not captured and stored, said filter operative on said supplemental computer.

30. A computer system as claimed in claim 25 wherein said computer system is a distributed computer system, wherein:
said server includes means for determining when said contemporaneous GPS data is within a predetermined distance of said any one of said plurality of task situs locations assigned to said task person, means for determining when said contemporaneous GPS data is within said drive corridor to any one of said plurality of task situs locations assigned to said task person, and means for determining when said contemporaneous GPS data is within a vendor situs location for the unique task assigned to said task person, and,
the distributed computer system includes a supplemental computer having a supplemental database populated with said plurality of tasks and plurality of unique task data collections and said task person data;
said blocking or discarding filter operative on said web-based server to block or discard GPS data which is not captured and stored in said server's database; and
a communications module to transfer contemporaneous GPS data which is not blocked or discarded to said supplemental database and said supplemental computer.
